(19) United States
(12) Patent Application Publication
(10) Pub. No.: US 2003/0219237 A1
(43) Pub. Date: Nov. 27, 2003

(54) Apparatus and method for digital recording of a film image

(75) Inventors: Thomas J. Bastasz, Chanhassen, MN (US); Louis F. Hill, Shoreview, MN (US); Patrick M. Farley, West St. Paul, MN (US)

Correspondence Address: MOORE, HANSEN & SUMNER, 2900 WELLS FARGO CENTER, 90 SOUTH SEVENTH STREET, MINNEAPOLIS, MN, 55402, US

(73) Assignee: Image Premastering Services, Ltd.

(21) Appl. No.: 10/155,685

(22) Filed: May 23, 2002

(51) Int. Cl. H04N 5/84; H04N 5/89

(52) U.S. Cl. 386/128; 386/130

(57) ABSTRACT

An apparatus and method for digitally duplicating and storing film images. The apparatus has a projection section that includes a low-power, white-light source of illumination and an image receiving section that includes a digital camera with a charge-coupled device. The apparatus also has a tunable liquid crystal filter that is used to produce monochromatic images onto the image receiving section. In operation, light from the illumination section is transmitted through the liquid crystal filter that is operating at a first, predetermined frequency, through the film image and onto the image receiving section for subsequent recordation. Then, the liquid crystal filter is tuned to a second, predetermined frequency and light from the illumination section is again transmitted through the same film image, and recorded. Once the requisite number of monochromatic images are recorded, they are recombined into a single image and transferred to an optical recording medium.

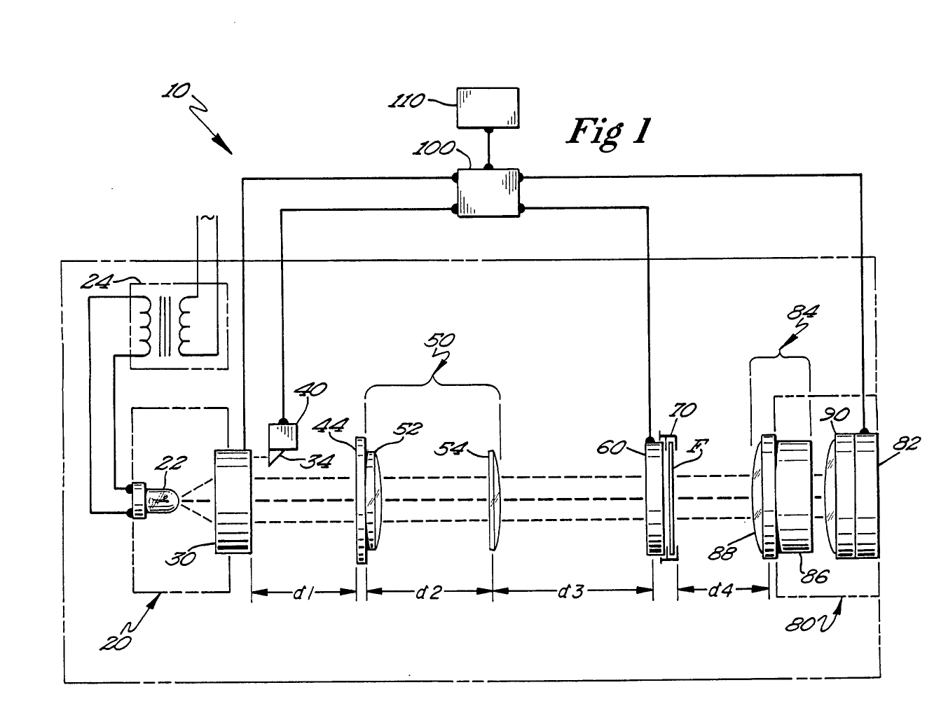

### FIELD OF THE INVENTION

This invention relates generally to historical preservation and archiving. More particularly, the present invention relates to an apparatus and method for digitally recording and storing film images, and specifically motion picture film.

### BACKGROUND OF THE INVENTION

Photographic film has been used for many years to record images for later viewing. The earliest films comprised a flexible base layer of cellulose nitrate that carried a photosensitive layer of emulsion. However, this film material was unstable and tended to be ignited by heat sources such as projection lamps. Its use was discontinued in favor of cellulose acetate and its successors cellulose diacetate, and cellulose triacetate. These films have greater stability than cellulose nitrate and are less prone to ignition. Of the acetate-based films, cellulose triacetate is currently being used. Another material that is being used for recording images is polyester (polyethylene terephthalate) film. This film is more suitable for recording images than cellulose triacetate, but it is difficult to manufacture and this results in increased cost. It is only now beginning to achieve widespread acceptance.

Initially, little thought was given to the storage of the film medium, and it was assumed that if it were stored under ambient room conditions, it would last indefinitely. However, as it was later discovered, that was not the case. As cellulose nitrate film ages, it oxidizes. Images fade and the film becomes yellowed and brittle. With further aging, the film surface starts to become tacky and it often fuses with adjacent film surfaces or with the surfaces of protective packaging or containers. Moreover, as part of the aging process, the film emits nitric oxide and nitrogen dioxide, which have a distinctive, noxious odor. In the final stages of decomposition, the film disintegrates into a brown acrid powder. Cellulose acetate film and its progeny (cellulose diacetate and cellulose triacetate) age in a similar manner. They, too, become yellowed and brittle. And, as with cellulose nitrate film, colors on cellulose acetate-base film lose their intensity and hue.

More importantly, the film dyes age at different rates. For example, blue and green dyes fade faster than red dye, and film often takes on a reddish hue. The acetate-based films also emit a characteristic odor. This odor, however, does not have a burnt smell like that produced by cellulose nitrate; but rather has the smell of vinegar, due to acetic acid. Thus, the cellulose nitrate and the cellulose-acetate based films can be identified and differentiated by smell alone. Polyester (polyethylene terephthalate) films do not become yellowed and brittle at the same rate as with the cellulose films. The emulsion layer, however, does age and the images in the emulsion layer can and do fade. A consequence of using the above-mentioned films is that most of the movies that have been made over the last eighty years are in danger of being irretrievably lost.

This unfortunate circumstance has not been lost on archivists, nor with people who work in the movie industry where the majority of movies have been made using the cellulose acetate-based films. Over the years, various methods have been developed to save, restore, and archive film. One method is to store the film at a low temperature and humidity, around 4 degrees Celsius and around 40 percent relative humidity, respectively. As one may expect, this retards the aging process to a considerable extent, and can greatly extend the life of film. However, this method of archiving can be expensive in terms of construction and subsequent operation. For example, large-scale operations often have custom-designed buildings with extensive air filtration systems, specialized illumination lamps, and non-reactive construction materials. Moreover, because electrical power could be interrupted, or the mechanical components could fail, such large-scale operations often have back-up systems, which have to be built and maintained. This all adds to the cost.

Another method of archiving involves making copies of a film in the primary colors of red, green, and blue, which may later be combined to create a color negative. However, this is an expensive undertaking, and long-term archiving is not assured because the copies are using the same medium and they, too, must be stored in a manner similar to storing older films.

Another method of preservation has been to transfer film images onto magnetic tape. With this type of archiving, known as telecine, an analog image is scanned, digitized, and recorded onto the tape. This presents no problem when there is only one image. However, when there are over one hundred thousand images, as in a motion picture, storage capacity and space become an issue. The solution to this problem has been to compress the images into one of several preferred formats. With this method, it is possible to record full-length motion pictures onto a manageable amount of magnetic tape, and it is possible to record such images at a resolution equivalent to standard and high-definition television formats. Unfortunately, this level of resolution is considerably less than the resolution as that of the film that is being archived. While this drawback does not present a problem when the image is displayed onto a small screen, it does become apparent when larger and larger display screens are used. Moreover, such a recording cannot then be used to make other “archival” recordings because they themselves are incomplete.

Disadvantages with the aforementioned method of archiving are twofold. First, the magnetic tape medium is not immune to oxidation and aging and it has an undetermined shelf life. In addition, it is sensitive to magnetic fields. Second, the images are stored on the tape in a format that may become obsolete in the future, making retrieval impossible. In spite of these drawbacks, many movies and television shows are being archived in this manner. Most telecine machines (for example, those manufactured by the French company Thompson and the English companies Cintel and Innovation TK) are able to convert 35 mm film to digital format, but do so only at a resolution that is adequate for transfer of film to standard and high definition television formats. They are not able to transfer film in a true archival format for 35 mm film. And, such machines are not without their drawbacks. One drawback is that they are relatively large and occupy a considerable amount of space. Another drawback is that the aforementioned machines generate a lot of heat, which can ruin the film that it is transferring. This excess heat generation is most often counteracted by providing such machines with elaborate cooling systems or by the inclusion of special light filters, fans, and insulation. Models that are more primitive physically distance the heat-generating components and the film being transferred, and this increases their size appreciably. All of this adds cost to the machines, and they typically cost well in excess of $1 million dollars.

Another drawback is that in spite of the exorbitant cost, their operation is not totally automatic. After initial recording, the images must be color-corrected because the machines are unable to accurately reproduce the color balance of the original film. This step is not performed by the machine, but is done by hand and entails the skills of trained operators. The major drawback in this step is that the final, color corrected film is dependent upon the judgment of the operator. As one may imagine, this judgment is subjective and may vary from operator to operator. For example, one operator may skew the balance towards the red end of the spectrum, while another operator may skew the same image towards the violet end of the spectrum. As one may well expect, the requirement of having skilled operators on hand to constantly monitor and adjust colors during the recording procedure is not very cost effective. For example, the cost of digitizing a color feature film can easily exceed $400,000. Moreover, the finished product will not be an exact copy and could easily be biased by the color-correction operator.

There is a need for a compact apparatus that is able to digitally duplicate and store images. There is also a need for a digital duplication apparatus that is able to record images in a high resolution, uncompressed format. There is yet another need for a duplication and storage apparatus that generates a minimum amount of heat and does not require heat-absorbing filters, fans, or cooling systems. There is also a need for an apparatus that has a minimum number of moving parts. And, there is a need for an apparatus that is able to function with a minimum amount of operator input.

### BRIEF SUMMARY OF THE INVENTION

The present invention comprises an apparatus that is able to duplicate and store a film image in a digital format. More specifically, the apparatus duplicates and stores motion picture film images in a digital format on an optical disc, and it does so without any substantial loss in resolution from that of the original motion picture film. Preferably, the film images are recorded in an uncompressed format to facilitate forward compatibility with new technologies that may be developed.

Briefly, the apparatus has a projection section, an optical section, a film holder, and an image-receiving section. The projection section comprises an illumination source that utilizes a very low wattage light source. As light emanates from the projection section and towards the optical section, it passes through a diffuser element, which eliminates hot and cold spots of illumination. Then, as the light passes through an optical section, it is formed into the proper configuration that will ensure proper and even illumination of the film image as it is retained in the holder. The light next passes through an adjustable filter to produce a substantially monochromatic light beam that is passed through the film image and on towards the image-receiving section. The image-receiving section comprises a photoelectric sensor array that is capable of substantially duplicating the resolution level of the original film. The image is then stored and/or recombined with other monochromatic images to form a unitary image that is digitized and stored in a predetermined medium.

More particularly, the illumination source of the projection section comprises a plurality of light-emitting diodes that have a combined color temperature around 4,000 to 9,500 degrees Kelvin. The adjustable filter is a tunable liquid crystal that may be driven at preselected frequencies and is located adjacent to the holder that temporarily retains the film during the duplication process. Preferably, the preselected frequencies correspond to the primary colors red, green, and blue. The photoelectric sensor array is a full-frame charge-coupled device that is provided with a lens assembly. Preferably, the charge-coupled device and lens assembly comprises a digital camera. And preferably, the charge-coupled device has a resolution that is able to duplicate the resolution of the film onto which the image has been recorded. The charge-coupled device is contained within the housing of a digital camera that includes a macro lens and an auxiliary optical lens. The image-receiving section may be provided with a contrast-enhancing lens element, if desired, which may be formed from photochromatic electrochromatic material. When an image is received, it is digitized and stored in a computer. Later, after further processing, the image is transferred to an optical medium.

An object of the present invention is to digitally duplicate and store a film image for archival purposes.

Another object of the invention is to digitally duplicate and store a film image at the same level of resolution in which it was recorded on film.

Another object of the present invention is to reduce errors in recording by reducing dependence upon operator input.

Yet another object of the invention is to facilitate the duplication process by reducing the number of moving parts.

A feature of the present invention is that the generation of heat during the duplication process is minimized by the use of light-emitting diodes.

Another feature of the invention is that the liquid crystal filter reduces the number of moving parts that may otherwise vibrate or jar the apparatus.

Another feature of the invention is that the liquid crystal may be tuned to a plurality of predetermined frequencies.

Still another feature of the invention is that optimum digital resolution is obtained by the use of a full-frame charge-coupled device having a minimum of column defects.

Yet another feature of the present invention is that the relatively short optical path permits compact construction.

An advantage of the present invention is that it is able to digitally duplicate and store a film image in an uncompressed format.

Another advantage of the invention is that errors in color rendition are reduced by minimizing operator input.

Additional objects, advantages and features of the invention will be set forth in part in the description which follows, and in part will become apparent to those skilled in the art upon examination of the following, or may be learned by practice of the invention. The objects and advantages of the invention may be realized and attained by means of the instrumentalities and combination particularly pointed out in the appended claims.

### BRIEF DESCRIPTION OF THE DRAWING

The figure depicted is a diagrammatic view of a preferred embodiment of the apparatus.

### DESCRIPTION OF THE PREFERRED EMBODIMENT

With reference to the drawing, the apparatus 10 comprising a projection section 20 at one end, and an image receiving section 80 at the other end is depicted. Starting with the projection section 20, the projection section 20 features an illumination source 22 whose output intensity is approximately 300 lumens at a color temperature of about 4,000 to 9,000 degrees Kelvin. This output is achieved using one or more light-emitting diodes (LEDs) that are arranged in a cluster, and which may be operatively connected to a constant-voltage power supply 24. The use of LEDs is preferred because they produce very little heat, and they do not require special filters, fans, or cooling systems. This allows the components of the apparatus 10 to be arranged in close proximity to each other, and the apparatus 10, itself, to be relatively compact. Moreover, the LEDs have exceptionally long operational lives, and low power consumption. Preferably, the LEDs have the same operational characteristics (ie., they emit light at the same color temperature and intensity). However, it will be appreciated that LEDs with different operational characteristics may be used, so long as the aforementioned output intensity of about 4,000 to 9,000 degrees Kelvin and 300 lumens is achieved. Preferably, the illumination source 22 comprises an array of light-emitting, gallium nitride diodes having a color temperature of about 8,000 degrees Kelvin.

Immediately in front of the projection section 20 is a shutter 30 whose operation is controlled by a central processing unit (CPU) 100. As will be discussed later on, the CPU 100 opens and closes the shutter 30 three times for each frame of color film, with each cycle leading to a recorded image having a different monochromatic color. Using the CPU 100 as a controller is desired because the monochromatic images usually require different lengths of exposure. For example, a red monochromatic image may require a shorter length exposure than a blue monochromatic image. Moreover, these differences in exposure times generally become greater as the film ages and the color densities change. Preferably, the shutter 30 is electromechanical, although it could comprise a liquid crystal, if desired.

Adjacent the shutter 30 is a beam splitter 34, which directs a portion of the light that passes through the shutter 30 to a photoelectric sensor 40. The photoelectric sensor 40 measures the intensity of the light and transmits this intensity level to the CPU 100, which compares the intensity level with a predetermined value and adjusts the timing of the shutter 30, as needed. Preferably, the photoelectric sensor 40 is a commercially available, charge-coupled-device (CCD) imaging photometer and radiometer (ie., a digital camera). It has been found that adequate results can be obtained with the ProMetric® 800 Imaging Photometer and Radiometer, and its associated software, which are available through Radiant Imaging of Duvall, Wash. 98019. However, it will be appreciated that other image analyzers may be used.

As the light from the projection section 20 passes through the shutter 30, its intensity may vary because the light produced by a plurality of sources. Therefore, a diffuser 44 is positioned downstream from the projection section 20. The diffuser 44 serves to remove the hot and cold spots produced by the LEDs and produces a light that is uniform in character. Preferably, the diffuser 44 is of an opal glass material and is positioned about a predetermined distance d1 of about 100 millimeters from the projection section 20.

As the light passes through the diffuser 44, it enters the optical section 50. The optical section 50 comprises two lenses 52, 54 that are configured and arranged to focus the diffused light to a predetermined area. The first lens 52 is has a correction factor of about +8 diopters and is positioned adjacent the diffuser 44. The second lens 54 has a correction factor of about +4 diopters, and is positioned a predetermined distance d2 of around 80 millimeters from the first lens 52. As will be appreciated, the correction factors and juxtaposition of the lenses 52, 54 may be varied to produce different results. Moreover, it will be appreciated that additional lens elements may be used.

Next, the diffused, and now focused light passes through a filter element 60. The filter element 60 is adjustable, and serves to separate a color film image into monochromatic colors, preferably red, green, and blue. Preferably, the filter element 60 is controlled and operated by the CPU 100, which determines the color and duration of each exposure. A feature of the filter element 60 is that it contains no moving parts. Instead, the filter element 60 comprises a tunable liquid crystal filter. As one may appreciate, this eliminates a potential source of vibration, jarring, and misalignment. A preferred liquid crystal filter element (and associated software) is the MicroColor-14™, which is available through CRI, Inc. of Woburn Mass, 01801. It will be appreciated, however, that other color filters such as beam-splitters and color wheels may be used. Preferably, the filter element 60 is positioned a predetermined distance d3 of around 100 millimeters from the second lens 54 of the optical section 50.

After light passes through the filter element 60, it passes through a film image F that is retained within a film holder 70. Preferably, the film holder 70 is a standard 35 mm film projection gate such as that found on the front end of an optical film printer. The film holder 70 includes sprockets that engage perforations in the film, which permits the holder 70 to accurately align each frame of a 35 mm film as it is advanced. The holder 70 may be motorized to facilitate automatic operation, or hand operated. Preferably, the holder 70 is positioned adjacent the filter element 60 to minimize light leakage and scatter.

As light passes through the film holder 70, it reaches the image receiving section 80, which comprises photoelectric sensor array 82 and a second optical section 84. Preferably, the photoelectric sensor array 82 comprises a charge-coupled-device (CCD) having a resolution about 2,000×1,500 pixels, or greater. More preferably, the photoelectric sensor array 82 comprises digital camera having a CCD, such as the Princeton PentaMax™ camera with a Kodak KAF-6300 grade-one chip, available through Roper Scientific, Inc. of Trenton, N.J. The aforementioned digital camera may be attached to the second optical section 84, which preferably comprises a 1:3.5 macro lens 86 and a +1 diopter lens element 88 that is attached to the front of the lens 86 with an appropriately sized adaptor. Preferably, the photoelectric sensor array 82 is in communication with the CPU 100. The forward end of the image receiving section 80 is positioned a predetermined distance d4 of about 145 millimeters from the film holder 70. As one may appreciate, the total optical path from the projection section 20 to the receiving section 80 is relatively short, between 300 and 1,000 millimeters. This results in an apparatus 10 that is portable, and which can be placed on a table-top, or other suitable support.

Sometimes, the image that reaches the CCD chip of the image receiving section loses some of its contrast. In order to restore contrast to the image, a contrast-enhancing lens element 90 comprising a photochromatic or electrochromatic material may be provided. Preferably, this lens element 90 is positioned immediately in front of the CCD chip of the photoelectric sensor array 82.

Operation of the apparatus as it digitizes a color image on a single frame of film is a follows. Initially, the particular film characteristics and values are entered into a database in the CPU 100, if needed. From this information, the lengths of exposures for the monochromatic images are estimated and stored in the system. The filter element 60 is then initialized to the color red. The film frame F with an image thereon is then positioned in the holder 70 and the recording process is started.

The recording process begins with the CPU 100 opening the shutter 30. When this happens, two things occur. First, a portion of the light that exits the shutter 30 is diverted by the beam splitter 34, measured and assigned a value by the photoelectric sensor 40, which is communicated to the CPU 100. Second, the intensity of the monochromatic image reaching the image receiving section 80 is measured by the photoelectric sensor array 82 and communicated to the CPU 100. The CPU 100 then compares the sensed values with the stored values and adjusts the length of the exposure, as needed.

As will be appreciated, the differences between the length of each monochromatic exposure for newer films will be at a minimum because their color densities will not have deteriorated significantly. However, as mentioned above, the dyes of the emulsion age at different rates and this often leads to a situation where the color density of older film is biased towards red, and shifted away from green and blue. The CPU 100 is able to automatically compensate for this shift in color densities so that all of the monochromatic images can be brought up to their original levels of intensity as closely as possible.

Continuing on, the correctly exposed monochromatic image is subsequently stored in the CPU 100. This procedure is repeated a second and third time, with the filter element 60 adjusted to the colors green and blue, respectively. After the blue, monochromatic image has been recorded, all of the monochromatic balanced images (red, green, and blue) are combined into one image, which may then transmitted to recording device 110. Preferably, the recording device 110 records the image onto an optical recording medium, such as a digital-video disc (DVD). Then the next film frame is recorded, and-so-on. It will be appreciated, that once the film is loaded into the apparatus, the recording process is more-or-less controlled by the CPU 100, and operator intervention is minimized.

As mentioned above, an important feature of the of the recording process is that the image receiving section 80 is, by virtue of its zero-column defect CCD, able to capture and store all of the original information on a frame at a very high resolution and in an uncompressed format. This includes not only the image portion on a frame, but the audio portion as well. It is understood that frames can be later reformatted or restored using conventional software programs, should the need arise.

As will be appreciated, it may be desirable to use more than one CPU, to speed up the recordation process. For example, one computer could be used to control the capture and combination of the images; a second to store, resize the images if necessary, and send completed images to permanent digital storage; and a third to sample light intensity each time the shutter is opened and send corroborating information to the first capture computer. Moreover, computers, personnel, and other equipment may be located remote from the invention to allow for a relatively contamination-free atmosphere for the usage of the invention.

The present invention having thus been described, other modifications, alterations or substitutions may present themselves to those skilled in the art, all of which are within the spirit and scope of the present invention. It is therefore intended that the present invention be limited in scope only by the claims attached below:

What is claimed is:

1. A apparatus for digitally duplicating and storing a film image, the apparatus comprising:
a projection section comprising a light-emitting diode;
a holder for temporarily retaining a film image while it is being duplicated and stored, the holder positioned a predetermined distance from the projection section; and,
an image receiving section comprising a photoelectric sensor array; with the image receiving section positioned a predetermined distance from the projection section.

2. The apparatus of claim 1, wherein the light-emitting diode has a color temperature in the range of around 4,000 to 9,500 degrees Kelvin.

3. The apparatus of claim 1, further comprising a light-diffusing element.

4. The apparatus of claim 1, wherein the predetermined distance between the projection section and the holder is between 200 to 500 millimeters.

5. The apparatus of claim 1, wherein the distance between the projection section and the image receiving section is between 300 to 1000 millimeters.

6. The apparatus of claim 1, further comprising a filter element.

7. The apparatus of claim 6, wherein the filter element is tunable.

8. The apparatus of claim 1, further comprising a contrast enhancing lens element.

9. The apparatus of claim 1, wherein the photoelectric sensor array comprises a charge-coupled device (CCD) having a resolution of about −2,000×1,500 pixels or greater.

10. A apparatus for digitally duplicating and storing a film image, the apparatus comprising:
a projection section comprising a plurality of light-emitting diodes;
a holder for temporarily retaining a film image while it is being duplicated and stored, the holder positioned a predetermined distance from the projection section; and, an image receiving section comprising a photoelectric sensor array; with the image receiving section positioned a predetermined distance from the projection section.

11. The apparatus of claim 10, wherein the plurality of light-emitting diodes have a combined color temperature in the range of around 4,000 to 9,500 degrees Kelvin.

12. The apparatus of claim 10, wherein the plurality of light-emitting diodes have a combined intensity of about 300 lumens.

13. A apparatus for digitally duplicating and storing a film image, the apparatus comprising:
a projection section comprising an illumination source;
a liquid crystal filter, the liquid crystal filter positioned a predetermined distance from the projection section;
a holder for temporarily retaining a film image while it is being duplicated and stored, the holder positioned in a predetermined position relative to the projection section; and,
an image receiving section comprising a charge-coupled device (CCD), with the image receiving section positioned a predetermined distance from the projection section.

14. The apparatus of claim 13, wherein the liquid crystal filter is tunable.

15. The apparatus of claim 13, further comprising a contrast enhancing lens element.

16. The apparatus of claim 13, wherein the contrast enhancing lens element comprises photochromatic material.

17. The apparatus of claim 13, wherein the illumination source comprises at least one light-emitting diode (LED).

18. The apparatus of claim 13, wherein the CCD has a resolution of about 2,000×1,500 pixels.

19. A system for digitally duplicating and storing a film image, the system comprising:
a projection section comprising an illumination source;
a holder for temporarily retaining a film image while it is being duplicated and stored, the holder positioned in a predetermined position relative to the projection section; and,
an image receiving section comprising a digital camera having a resolution of about 2000×1500 pixels or greater, with the image receiving section positioned a predetermined distance from the projection section.

20. The system of claim 19, wherein the illumination source comprises at least one light-emitting diode.

21. The system of claim 19, further comprising a filter element, the filter element positioned a predetermined distance from the projection section.

22. The system of claim 21, wherein the filter element is tunable.

23. The system of claim 19, wherein the predetermined distance between the projection section and the image receiving section has an optical path in the range of around 300 to 1,000 millimeters.

24. A method of digitally recording a film image, the method comprising the steps of:
providing a duplicating and storage apparatus having a projection section, a holder, a tunable liquid crystal filter, and an image receiving section;
positioning a film image in the holder so that it is between the projection section and the image receiving section;
actuating the projection section to emit light through the liquid crystal filter and the film image and onto the image receiving section; and,
recording the image.

25. The method of claim 24, wherein the step of recording the image comprises the step of transferring the image onto an optical storage medium.

26. A method of digitally recording a film image, the method comprising the steps of:
providing a duplicating and storage apparatus having a projection section with at least one light-emitting diode, a holder, and an image receiving section;
positioning a film image in the holder so that it is between the projection section and the image receiving section;
actuating the projection section to emit light through the film image and onto the image receiving section; and,
recording the image.

27. The method of claim 26, wherein the step of recording the image comprises the step of transferring the image onto an optical storage medium.

28. A method of digitally recording a film image, the method comprising the steps of:
providing a duplicating and storage apparatus having a projection section, a holder, and an image receiving section comprising a digital camera;
positioning a film image in the holder so that it is between the projection section and the image receiving section;
actuating the projection section to emit light through the film image and onto the image receiving section; and, recording the image.

29. The method of claim 28, wherein the step of recording the image comprises the step of transferring the image onto an optical storage medium.
